(19) United States
(12) Patent Application Publication
(10) Pub. No.: US 2012/0045306 A1
(43) Pub. Date: Feb. 23, 2012

(54) UTILITY WAGON AND AN ATTACHABLE LEAF CHUTE

(76) Inventor: Harold FISHER, Piscataway, NJ (US)

(21) Appl. No.: 12/860,712

(22) Filed: Aug. 20, 2010

(51) Int. Cl. B60P 1/00; B65G 11/00; B62B 3/10

(52) U.S. Cl. 414/523; 280/29; 280/47.34; 193/2 R

(57) ABSTRACT

A wagon comprising a body portion, the body portion including a plurality of side portions, each of the side portions comprising wire or plastic sides. The wagon also comprises a plurality of reinforcing metal strips on a top and bottom of each of the wire sides; and a plurality of metal strips which extend from the top to the bottom of the body portion. Finally, the wagon includes a plurality of tie down straps in metal or plastic straps extending from a top portion of and side of the utility wagon. When an attachable leaf chute is combined with the utility wagon, it can also fill individual bags with leaves. The attachable leaf chute slides into and then is attached to the utility wagon.

### FIELD OF THE INVENTION

The present invention relates generally to a utility wagon and more specifically to a utility wagon with an attachable leaf chute.

### BACKGROUND OF THE INVENTION

There is a need for a utility wagon which has many different uses and which can be used by people without the use of additional, often heavy (such as a motor) equipment. Often a utility wagon can be used for a particular purpose, but not for many different items, such as bringing large garbage cans or bags for pick up and then return these to the house or shed once they have been emptied, and yet at the same time it can also be used, for example, for decorations and displays for holidays and seasons.

The utility wagon in accordance with the present invention can accomplish many different purposes, yet the utility wagon is simple in design and may be pushed and pulled by a person without additional equipment. The present invention addresses such a need.

### SUMMARY OF THE INVENTION

A wagon comprising a body portion, the body portion including a plurality of side portions, each of the side portions comprising wire or plastic sides. The wagon also comprises a plurality of reinforcing metal strips on a top and bottom of each of the wire sides; and a plurality of metal strips which extend from the top to the bottom of the body portion. Finally, the wagon includes a plurality of tie down straps in metal or plastic extending from a top portion of and side of the utility wagon. When an attachable leaf chute is combined with the utility wagon, it can also fill individual bags with leaves. The attachable leaf chute slides into and then is attached to the utility wagon.

### BRIEF DESCRIPTION OF THE DRAWINGS

FIG. 1 illustrates a side view of a utility wagon in accordance with the present invention.

FIG. 2 illustrates a bottom view of a utility wagon in accordance with the present invention.

FIG. 3A illustrates a rear view of a utility wagon in accordance with the present invention.

FIG. 3B illustrates a front view of a utility wagon in accordance with the present invention.

FIG. 4A illustrates a front top view of the attachable leaf chute.

FIG. 4B illustrates a side view of the attachable leaf chute.

FIG. 4C illustrates another side view of the attachable leaf chute.

FIG. 4D illustrates a top view of a utility wagon with the attachable leaf chute.

FIG. 5A illustrates a side view of the presser/stuffer rake.

FIG. 5B illustrates a front view of the presser/stuffer rake.

### DETAILED DESCRIPTION

The present invention relates generally to a utility wagon and more specifically to a utility wagon with an attachable leaf chute. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

### Utility Wagon 10

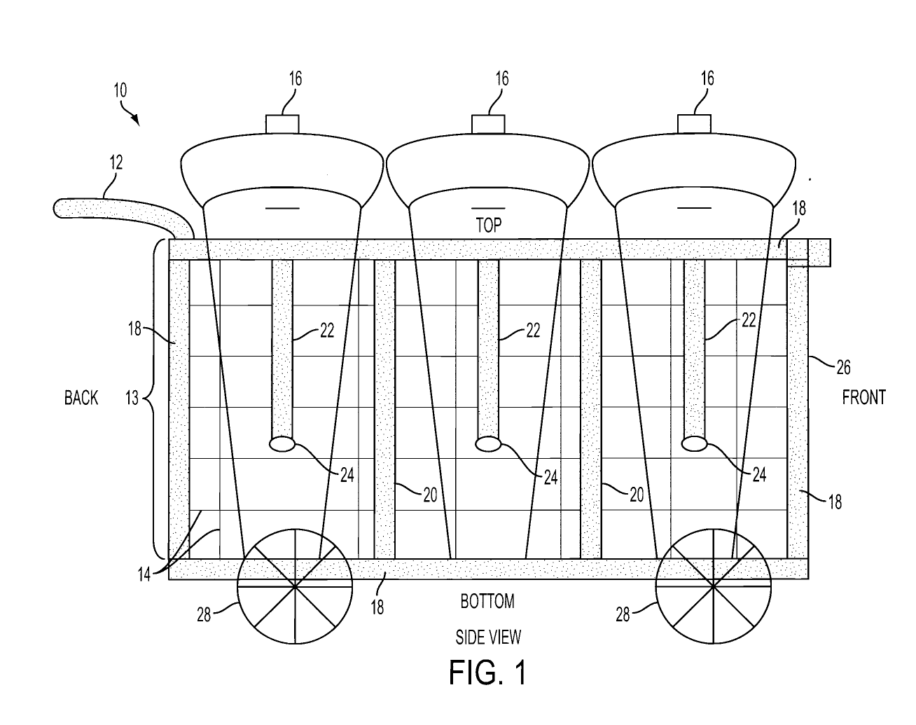

FIG. 1 shows a side view of a utility wagon 10. The wagon 10 includes a handle 12 (a shopping cart-type of handle or a similar type of handle). The height 13 of the wagon can be, for example, from 2.5 feet to 3 feet, so as to make it easy for people to push and move about. The wagon also includes wire sides 14 on all four sides of the utility wagon 10. There is a reinforcing metal strip railing 18 on the bottom and top sides, which extends around the entire utility wagon 10. There are also metal strips 20 which extend from the top to the bottom of the utility wagon 10. Holding or tie down metal or plastic straps 22 extend from the top of one side of the utility wagon, and these are each fastened with hooks 24 on the opposite side of the wagon.

In the side view on the front side of the utility wagon 10 of FIG. 1, there is a front gate or door 26. This pulls down from the top or it can open from one side.

The utility wagon 10 includes four wheels 28, so that it can be moved easily.

FIG. 1 illustrates three (3) large garbage cans which can be inside the utility wagon 10. Of course, other sizes of cans and bags could also be used. The inside of the utility wagon 10 could additionally be used for recycling containers, potted plants and small trees, decorations and displays during holiday season, empty or filled commercial water jugs; as well as storing office, janitorial, and laundry supplies; hauling bags of dirt, tools, small machines, and fertilizer for garden purposes; and even as a temporary holding pen for small and newborn pets. These are some ways in which the utility wagon 10 could be used, but the use of the utility wagon has many other possibilities as well.

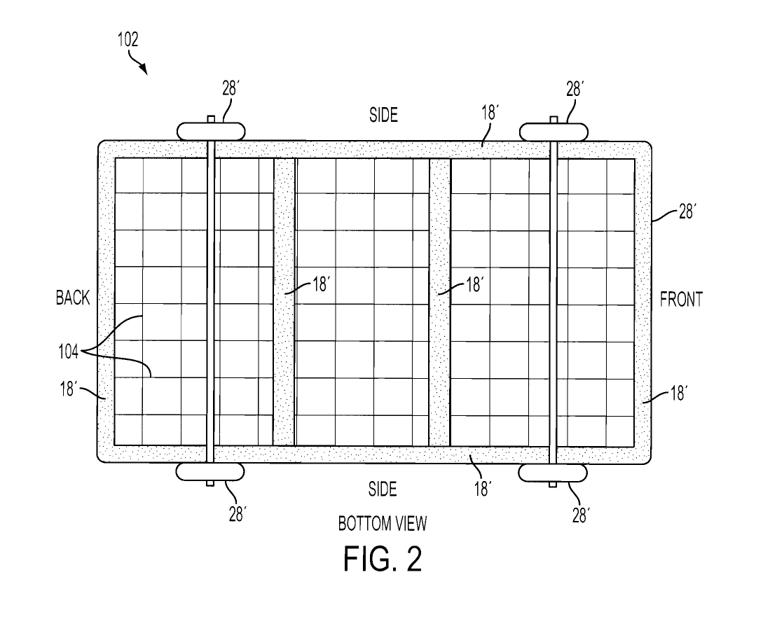

FIG. 2 shows the bottom view 102 of the utility wagon 10′. The bottom view of the utility wagon 10′ includes a wire bottom 104. There are four wheels 28′. On the bottom, in the middle, sides, front, and back there are reinforcing metal or plastic strips 18′ or a railing. The front gate or door 26′ can be seen, which again can be opened either by pulling the door open down from the top or the door can be opened from the side.

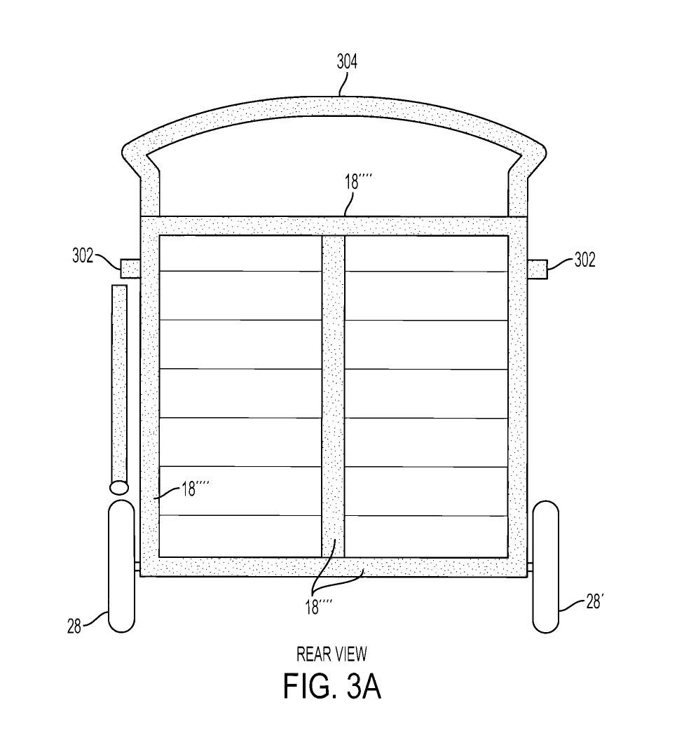

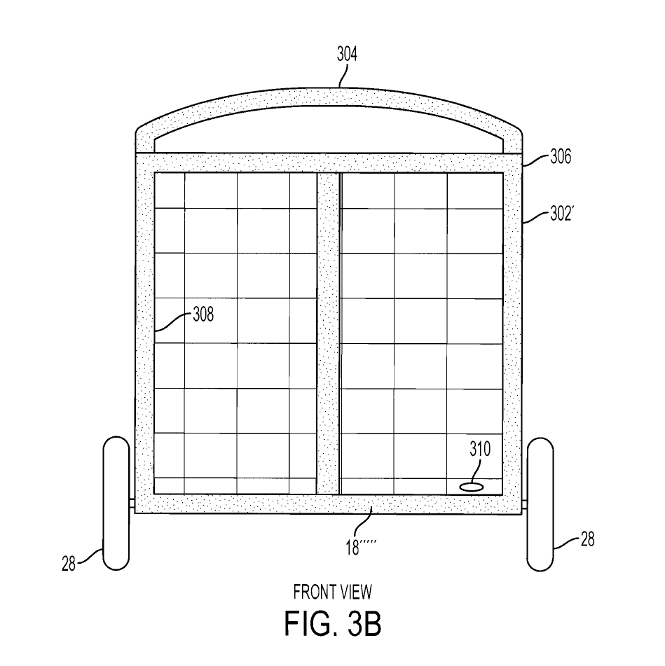

In FIG. 3a, from the rear view the utility wagon 10 includes reinforcing metal or plastic strap hooks 302. There are also reinforcing metal or plastic strips 18′″. As is seen, there is the push/pull handle 304 and a reinforcing metal or plastic strip 18′″ which goes across the top of the utility wagon 10.

In FIG. 3b, from the front view the utility wagon 10 includes strap hooks 302′, a push/pull handle 304′, and reinforcing metal or plastic strips 18′″″. There is also a hatch 306, side hinges 308 and bottom hinges 310. The side hinges 308 open so that the door or gate opens from one side. A set of bottom latches 310 enables the door or gate to open from the top.

### Features of the Utility Wagon 10

The utility wagon 10 can accomplish many different things. For example, the following give examples, but do not limit, what the utility wagon can do.

The utility wagon 10 can hold a plurality of large garbage cans. It can be pushed to the curb for garbage pickup. Empty cans can be returned to the wagon and then brought back to the house. It can also hold a plurality of large garbage bags, for example, for pickup.

The utility wagon 10 can prevent empty cans from blowing away. It can hold recycling containers for pick up (stacks of folded cardboard or newspapers), but there are many other similar or related possibilities, of which the above are only an example. The utility wagon 10 can hold potted plants, small potted trees, and flowers. It can also be used for decorations and displays for holidays and seasons. The utility wagon 10 can be relocated to any place on a property. It can be kept outside, for instance, since it is weather resistant. The utility wagon 10 can haul bags of dirt, plants, tools, small machines and fertilizer for gardening or building purposes. It is a carry-all for outdoor events.

The utility wagon 10 can hold filled or empty commercial water jugs. It can also be used to store office, janitorial, and laundry supplies. It can be used as a temporary holding pen for small or newborn pets, and it is easily attached to a fence, pole, and/or a tree.

### The Attachable Leaf Chute 400

An attachable leaf chute 400 in conjunction with the utility wagon 10 can be utilized for filling bags with leaves.

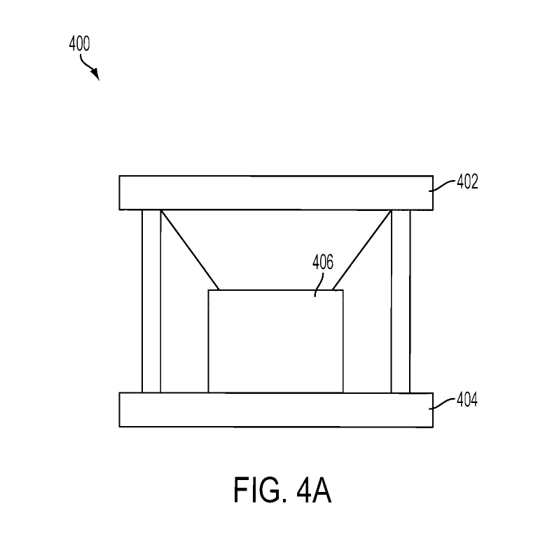

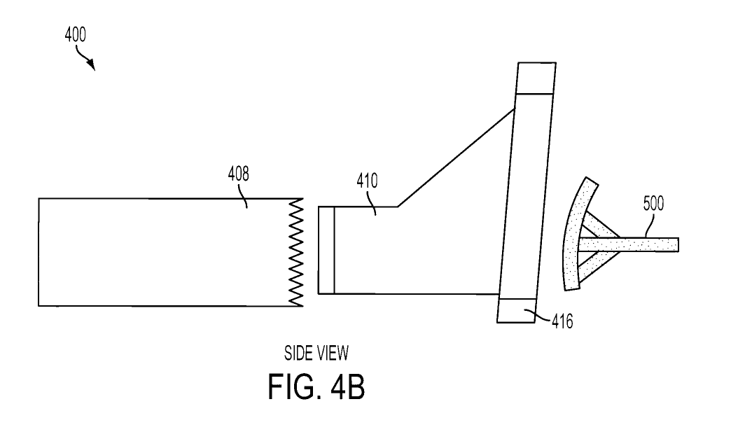

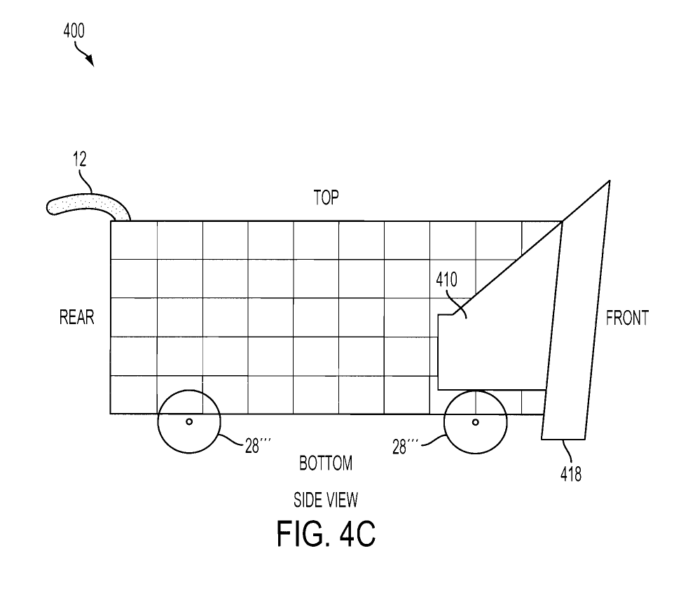

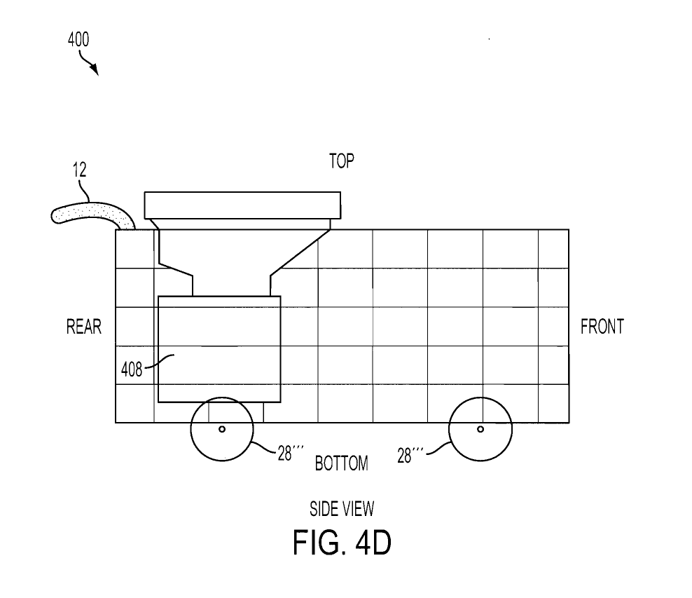

The attachable leaf chute 400 is illustrated in FIGS. 4A-4D. If a person wants, a person can use a hand-held, shoulder-held or push model blower to push leaves or the like into the wagon via the chute 400. However, the blower is not part of a system and method in accordance with the present invention.

FIG. 4A is a front view of the leaf chute 400. The leaf chute 400 is a trapezoidal shape which includes top guard 402, bottom guard 404, and a grass leaf door at one end.

FIG. 4B illustrates a sleeve 410 of the chute 400 coupled to a leaf grass bag 410. The leaves or the like that are placed in the chute 400 can be pushed into the bag via the leaf stuffer/press rake 500. In so doing, the system can be used to compactly remove leaves and the like from a yard.

The leaf chute 400 can be utilized with the wagon 10 in two fashions. The chute can be used at a front load on the front of the wagon 10 or it can be at the top load on the front of the wagon 10.

### Front Load

FIG. 4C illustrates the leaf chute being used as a front load device. To use the attachable leaf chute 400, slide it into the front end of the utility wagon 10 with side hooks on attachment for both sides of the wagon.

A leaf/grass blower (not shown) can be used to blow the leaves into the front opening of the attachable leaf chute 400, or the leaves may be raked into the attachable leaf chute using the presser/stuffer 500 (FIG. 4) into the front opening of the attachable leaf chute 400.

### Top Load

FIG. 4D illustrates the leaf chute 400 being used as a top load device. In the top load the chute 400 hooks into the top of both sides of the utility wagon 10. A lawn mower bag or leaf vacuum bag full of leaves and grass can be shaken into the sleeve 410 of the chute. Leaves can also be collected and placed into the sleeve. A long handle presser/stuffer rake 500 is used to push leaves and grass in order to fill the bag.

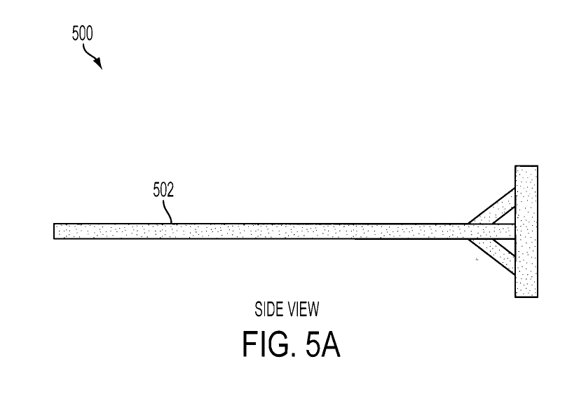

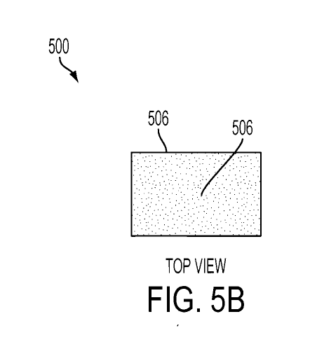

FIGS. 5A and 5B illustrate the long handle presser/stuffer rake 500. The long handle presser/stuffer rake 500 is used to push leaves or grass through the chute 400 into the bag. As is seen, the presser/stuffer 500 includes a long handle 502 coupled to a substantially rectangle (FIG. 5B) presser portion 504. The presser portion is held in place by joints 506.

### CONCLUSION

A utility wagon which is easy to use, can accomplish many different things, with the addition of the attachable leaf chute and a long-handle Press can fill individual bags with leaves in an efficient and effective manner.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A wagon comprising:
a body portion, the body portion including a plurality of side portions, each of the side portions comprising a plurality of sides;
a plurality of reinforcing metal strips on a top and bottom of each of the wire sides;
a plurality of metal strips which extend from the top to the bottom of the body portion; and
a plurality of tie down straps extending from a top portion of and side of the utility wagon.

2. The wagon of claim 1, wherein each of the side portions comprise wire.

3. The wagon of claim 1, wherein each of the side portions comprise plastic.

4. The wagon of claim 1, wherein the wagon includes a handle portion.

5. The wagon of claim 1, wherein the wagon includes a front gate.

6. A leaf chute assembly comprising:
a trapezoidal member, the trapezoidal member including a top guard and a bottom guard; and
a door member coupled to the trapezoidal member to allow for leaves to be pushed through.

7. The leaf chute assembly of claim 6, wherein the leaf chute assembly is utilized in a front portion of the wagon.

8. The leaf chute assembly of claim 6, wherein the leaf chute assembly is utilized in a top portion of the wagon.

9. A system comprising:
a wagon; and
a leaf chute coupled to the wagon, wherein a trapezoidal member, the trapezoidal member including a top guard and a bottom guard; and
a door member coupled to the trapezoidal member to allow for leaves to be pushed through.

10. The system of claim 9 wherein the wagon includes:
a body portion, the body portion including a plurality of side portions, each of the side portions comprising a plurality of sides; a plurality of reinforcing metal strips on a top and bottom of each of the wire sides; a plurality of metal strips which extend from the top to the bottom of the body portion; and a plurality of tie down straps extending from a top portion of and side of the utility wagon.

11. The system of claim 9, wherein each of the side portions comprise wire.

12. The system of claim 9, wherein each of the side portions comprise plastic.

13. The leaf chute assembly of claim 9, wherein the leaf chute assembly is utilized in a front portion of the wagon.

14. The leaf chute assembly of claim 9, wherein the leaf chute assembly is utilized in a top portion of the wagon.
